(19) United States
(12) Patent Application Publication
(10) Pub. No.: US 2010/0010666 A1
(43) Pub. Date: Jan. 14, 2010

(54) System to secure, control, inventory and dispense items

(76) Inventor: Patrick Adams, Kamuela, HI (US)

Correspondence Address: PEACOCK MYERS, P.C., 201 THIRD STREET, N.W., SUITE 1340, ALBUQUERQUE, NM, 87102, US

(21) Appl. No.: 12/499,043

(22) Filed: Jul. 7, 2009

Related U.S. Application Data
(60) Provisional application No. 61/134,034, filed on Jul. 7, 2008.

(51) Int. Cl. G06F 17/00

(52) U.S. Cl. 700/231

(57) ABSTRACT

A safe/secure cabinet that preferably protects and deters the internal and external threat of theft and robbery most preferably for use with controlled and non-controlled items.

### CROSS-REFERENCE TO RELATED APPLICATIONS

This application claims priority to and the benefit of the filing of U.S. Provisional Patent Application Ser. No. 61/134,034, entitled “PharmaSafe Pharmacy Safe with Time-Delay Automated Counting Technology, Authorization Required Time-Delay Safe Door, Pharmacy Software Interface and Electronic Control Inventory Log for Perpetual Inventory”, filed on Jul. 7, 2008, and the specification thereof is incorporated herein by reference.

### BACKGROUND OF THE INVENTION

1. Field of the Invention (Technical Field)

Embodiments of the present invention relate to a safe/secure cabinet and system that preferably protects and deters the internal and external threat of theft and robbery, especially useful for controlled and non-controlled pharmaceutical medications and other applications. An embodiment incorporates several technologies to secure, control, electronically inventory and dispense contents of the system.

2. Description of the Prior Art

Prior art devices store medication inventory in predetermined quantities. Specific individualized doses for a particular patient cannot be delivered. In many small hospitals, medications are dispensed outside the pharmacy and this is usually done with a medication cabinet that can only dispense what is already pre-prepared by the pharmacy.

### BRIEF SUMMARY OF THE INVENTION

An embodiment of the present invention relates to a safe for securing and monitoring an inventory of products which includes a product storage area, at least one product dispensing unit, a locking mechanism inhibiting access to products disposed within said safe, and a reporting system which includes a processor executing software stored in a tangible computer-readable medium, the software causing the processor to generate at least one report, and the processor executing the software and maintaining an inventory log of dispensed products and a user's access. The safe can also include an authorization mechanism, which authorization mechanism can optionally require entry of biometric data. The reporting system can continuously maintain an inventory control log, and the log can include information required to comply with a law or with a governmental regulation.

In one embodiment, the reporting system can record one or more of the following: a time when the safe is opened, a time when the safe is closed, a time when a breach in a security feature of the safe occurs, the identity of an individual, and a combination thereof. Optionally, a specific authorization sequence can be required in order to obtain a product stored within the safe. The safe can be compartmentalized into a plurality of areas wherein at least some of the areas are independently lockable. The reporting system can optionally generate a perpetual inventory snapshot. Optionally, the safe can include automated product counting. The safe can also optionally report in real-time.

In one embodiment, the safe can include one or more product back-stock containers. The safe can also optionally include a user-authentication for product dispensing. The safe can further include a user-authentication for product inventory reporting. Optionally, the safe can be caused to dispense a product from an instruction sent from a remote location. Optionally, the safe can be disposed within a nursing area. The safe can also include an adjustable product dispensing time delay. The inventory log can be directly electronically transmittable, and the inventory log can include a perpetual inventory log.

An embodiment of the present invention also relates to a method for dispensing a product and maintaining a product inventory log which method includes providing a safe cabinet, the cabinet capable of storing and dispensing a product; and a computer executing software stored on a tangible computer-readable media wherein the computer maintains an inventory control log for product dispensed from the cabinet and records an identity of a user who accesses the safe cabinet. The computer can cause product to be automatically dispensed from a secure location within the cabinet, which can optionally be in response to data from a prescription being input into the computer. The data can be input into the computer at a location within a same building where the cabinet is disposed, or the data can be input into the computer at a location which is not within a same building wherein the cabinet is disposed. Optionally, the inventory control log can comprise information required by a governmental body which can be required by a governmental regulation. In one embodiment, the cabinet can include a metal enclosure. The software can cause the computer to require an authentication prior to dispensing product. The product dispensed can include a controlled substance. The method can optionally require user authentication prior to dispensing the product.

An embodiment of the present invention also relates to a method for generating an electronic perpetual inventory control log which includes providing a system for dispensing pharmaceutical prescriptions, the system automatically maintaining an electronic perpetual inventory control log. The log can be electronically transmitted to an appropriate governmental body.

Objects, advantages and novel features, and further scope of applicability of the present invention will be set forth in part in the detailed description to follow, taken in conjunction with the accompanying drawings, and in part will become apparent to those skilled in the art upon examination of the following, or can be learned by practice of the invention. The objects and advantages of the invention can be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is an illustration of a front view of an embodiment of the present invention;

FIG. 2 is an illustration of a perspective view of the FIG. 1 embodiment;

FIGS. 3a and 3b are illustrations of an inventory log and a perpetual inventory report;

FIG. 4 is an illustration of a perspective view of the FIG. 1 embodiment with the side panel removed;

FIG. 5 is an illustration of a perspective view of the FIG. 1 embodiment with the side and front top panel removed;

FIG. 6 is an illustration of a perspective view of the FIG. 1 embodiment with the side and front top panel removed and illustrating the interior of the cabinet;

FIG. 7 is an illustration of a front view of a frame according to an embodiment of the present invention;

FIG. 8 is an illustration of a back view of an embodiment of the present invention with side panel removed;

FIG. 9 is an illustration of a front view of a frame according to an embodiment of the present invention;

FIG. 10 is an illustration of a front view of a completely bare frame according to an embodiment of the present invention;

FIG. 11 is an illustration of a front view of a frame according to an embodiment of the present invention with a top shelf and bottom drawers;

FIG. 12 is an illustration of a perspective view of an embodiment of the present invention;

FIG. 13 is a front view drawing illustrating a closed cabinet according to an embodiment of the present invention;

FIG. 14 is an illustration of a close up front view of a bottom drawer opening;

FIG. 15 is an illustration of a close up bottom view of a drawer opening;

FIG. 16 is an illustration of a dispenser according to an embodiment of the present invention;

FIG. 17 is a drawing of a flow chart which illustrates some steps which can occur when a prescription is filled and dispensed; and

FIG. 18 is a drawing of a flow chart which illustrates some steps which can occur when a pharmacy's inventory is replenished.

### DETAILED DESCRIPTION OF THE INVENTION

Embodiments of the present invention relate to an intelligent safe and/or secure cabinet which can have a plurality of models of various sizes that contain various numbers of dispensers for a specific number of pharmaceutical narcotic/controlled and/or non-controlled medications for security and for inventory control and logging. The invention can also be used for dispensing other items besides medications, including but not limited to firearms, ordinance, chemicals, substances, biological materials, gems, precious metals, etc. The descriptions to pharmaceuticals and medications as set forth herein are for purposes of illustrating one application of the present invention, however, the invention is not limited to pharmaceuticals and medications and can be used for any item requiring control and/or inventory and/or dispensing and/or security.

Embodiments of the present invention reduce and/or prevent access and handling of items thereby reducing the opportunity to divert items. In addition, embodiments of the present invention use dispensing technology to preferably automatically count the items thereby reducing the opportunity for human error. Records and inventory can be kept with regard to each item dispensed. The cabinet comprising the safe can have a time delay on the door and preferably each access is controlled and recorded.

The terms “safe” and/or “cabinet”, as used throughout the specification and claims, is intended to include any device, apparatus or structure capable of deterring or otherwise inhibiting, at least partially, access to the contents or items therein by one or more persons. The terms “cabinet” and “safe” are used interchangeably throughout the specification and claims. Throughout the specification and claims the safe and/or cabinet preferably comprises an intelligent device with onboard processing and memory capability. The term “intelligent” as used throughout the specification and claims includes but is not limited to the capacity to acquire and apply knowledge and can be used in conjunction with the term “software”.

The terms “product”, “item”, and/or “contents” as used throughout the specification and claims includes but is not limited to any physical item or substance that can be offered to a market that might satisfy a want or need. In addition, in some embodiments, the terms “medication(s)” or “pharmaceutical(s)” are used interchangeably with the term “product” or “item”.

The terms “narcotic” and/or “controlled substance” as used throughout the specification and claims are defined by Federal and State regulations and laws. Controlled substance includes Scheduled I-V medications. The term “pharmaceutical formulation” as used throughout the specification and claims includes but is not limited to the specific form of the narcotic/controlled substance e.g. pills and tablets. The term “prescription” as used throughout the specification and claims includes but is not limited to an order to fill and dispense one or more medications.

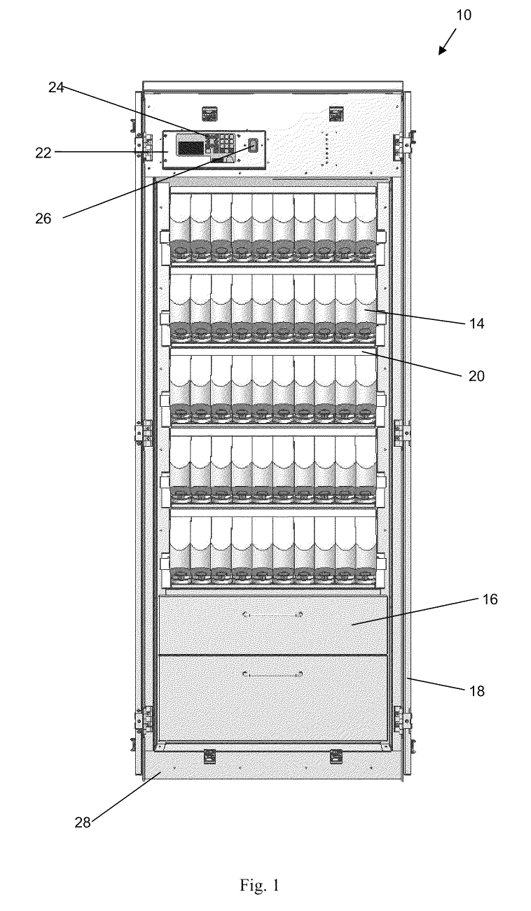

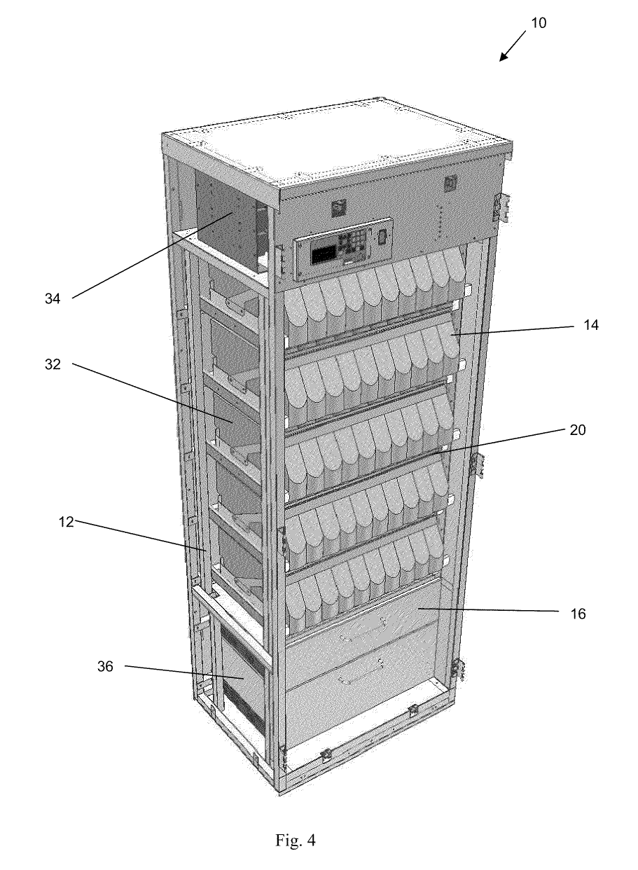

FIG. 1 illustrates a front view of an embodiment of the present invention. Cabinet 10 can be a free-standing unit or incorporated into an overall filling system and preferably comprises a cabinet. In this embodiment, cabinet 10 preferably includes: frame 12 (see FIG. 4) that preferably structurally holds dispensers 14, bottom drawers 16, hinged doors 18, and dispenser securing mechanism 20. In one embodiment, locking control mechanism 22 is controlled by keypad 24 which can activate alarm 26. Cabinet 10 prevents access to medications and/or items by persons unless authorized by locking control mechanism 22. Locking control mechanism 22 can be electronic or manual and can have specific authorization requirements for entry. Locking control mechanism 22 can record times of opening, closing and any breaches. Each user can have a specific authorization sequence to gain access so that his/her specific code is recorded on a log. Cabinet 10 preferably comprises a stand alone unit that can be manually operated or connected to dispensing software for dispensing. Locking control mechanism 22 and keypad 24 preferably limit access to the safe by an individual, (e.g. controlled substances dispensing software) preferably time controlled and recorded. Locking control mechanism 22 and keypad 24 optionally gather and/or provide information to access cabinet 10. Locking control mechanism 22 optionally allows one or more time delays for dispensing and/or opening cabinet 10 and can be set by each pharmacy based on its particular needs or can be preset. In another embodiment, one or more delays can be introduced in another system, optionally via software.

Cabinet 10 is optionally made from various materials including steel, aluminum, titanium, a composite, plastic material, or any combination thereof, that prevents compromise for gaining entry into cabinet 10. Locking control mechanism 22 can vary according to application and can operate mechanically, digitally or by any means that resists or otherwise inhibits the ability of a non-authorized individual to gain access to cabinet 10 and can optionally include, but is not limited to keypad 24. Dimensions of cabinet 10 can be virtually any size and shape depending on the number of dispensers 14, or containment mechanisms including but not limited drawers, shelves, combinations thereof and the like, as well as the application to a specific area of the industry. The interior of the safe can be compartmentalized so each specific area can be lockable. Alternatively, larger sections can be lockable, while some areas allow ease of access, or any combination thereof. Access to each locked portion of cabinet 10 optionally requires the authorized user specific code and can be illustrated on the access log. Forced entry or any perceived unauthorized dispensing of product can set off any number of alarms and checks thus initiating a chain of events to secure the contents of cabinet 10 or alert appropriate persons to prevent entry and thus prevent losses from cabinet 10. Entry to any embodiment can require one or more criteria, including, by way of a non-limiting example only, authorized users can use an electronic or manual code, Dulles key, electronic card, biometrics, a touch pad, any other system, apparatus, or method capable of enabling a user to identify themselves individually or as a group, which can be on cabinet 10, or remote from cabinet 10, or any combination of entry modes, that is given to the authorized party that gives him/her a unique entry into the safe, combinations thereof, and the like. The alarms can be silent or can be audible and/or visual. Any breach can send electronic signals to appropriate authorities, representatives of a company, or any remote or on-site safety system. Perpetual inventory can be kept within the software contained in the safe, or remote from the safe.

Embodiments of the present invention can integrate pharmaceutical dispensing technology known in the industry with the locking depository safe and/or cabinet, inventory management software and reporting system providing a user ready product for counting, dispensing, tracking and reporting on controlled products. An embodiment of the present invention solves the problem of simultaneously physically securing, processing and quantity tracking of an item and providing the reports required by government agencies and management.

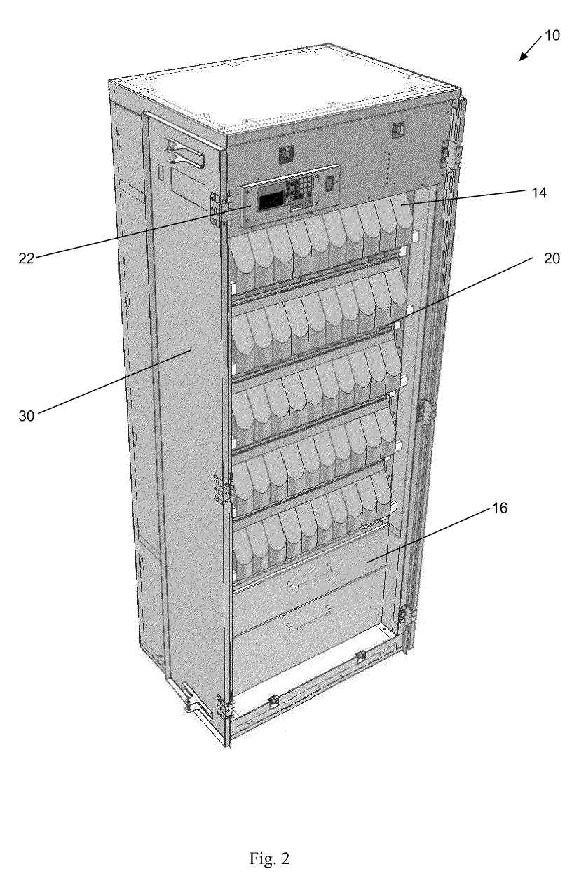

FIG. 2. illustrates a perspective view of cabinet 10 with dispensers 14 as individual housing units within cabinet 10 capable of holding a pharmaceutical formulation. Cabinet 10 preferably comprises locking door 30 and drawers 16. An embodiment contains electronic counting technology for pharmaceutical pills, tablets or any other medication or item that requires or otherwise benefits from security. The exact count of medications for each prescription or medication order can be counted out by automated counting technology. Items can be dispensed immediately or delayed for a specified time. A delay can alternatively be provided between subsequent dispensals of items. Ranges of delay include but are not limited to between approximately one minute to approximately 24 hours; between approximately one minute and approximately 15 minutes; and between approximately 30 seconds to approximately five minutes. The amount of delay time can be set by an authorized agent. An authorized agent is preferably set by an officer or other designee of the company with authority to access the cabinet. In one embodiment, locking control mechanism 22 cannot be changed by any other persons unless the authorized agent gives such authority. Each change to the specified time can optionally be on an electronic log along with the authorized agent name or mark. Software for the preferred embodiment retains these changes in the electronic log and reporting system. The counting technology can be specifically made for an embodiment of the present invention. The counting technology can be manual or electronic. Counting technology can deliver any types of dosage forms and containers including but not limited to pills, capsules, crèmes, liquids, vials, tubes, ovals, bottles, pre-filled syringes, ampules or other items. Dispensers 14 preferably deliver or allow access to one or each of these dosage forms. Cabinet 10 can optionally secure a plurality of medications in a shelving system while preventing access to a selected medication using locking control mechanism 22 while generally limiting access to all medications. For example, dispenser 14 can preferably dispense an exact count or can supply a stock bottle that is poured from a manually counted prescription while the remainder of the medication is returned to bottom drawer 16 where it is again securely locked until the next authorized usage. FIG. 4 illustrates the FIG. 1 embodiment with side panel removed to illustrate shelving units 32, control board 34 and interior drawers 36. Embodiments of the present invention can preferably provide a configurable time delay from when a prescription is received until the apparatus starts counting the medications to fill the prescription or between subsequent doses of a medication.

Embodiments of the present invention increase security by ensuring that the appropriate time delay configuration is set so that it cannot be easily changed during daily or routine use of the cabinet. A preferred embodiment integrates into virtually any existing pharmacy and/or automated system.

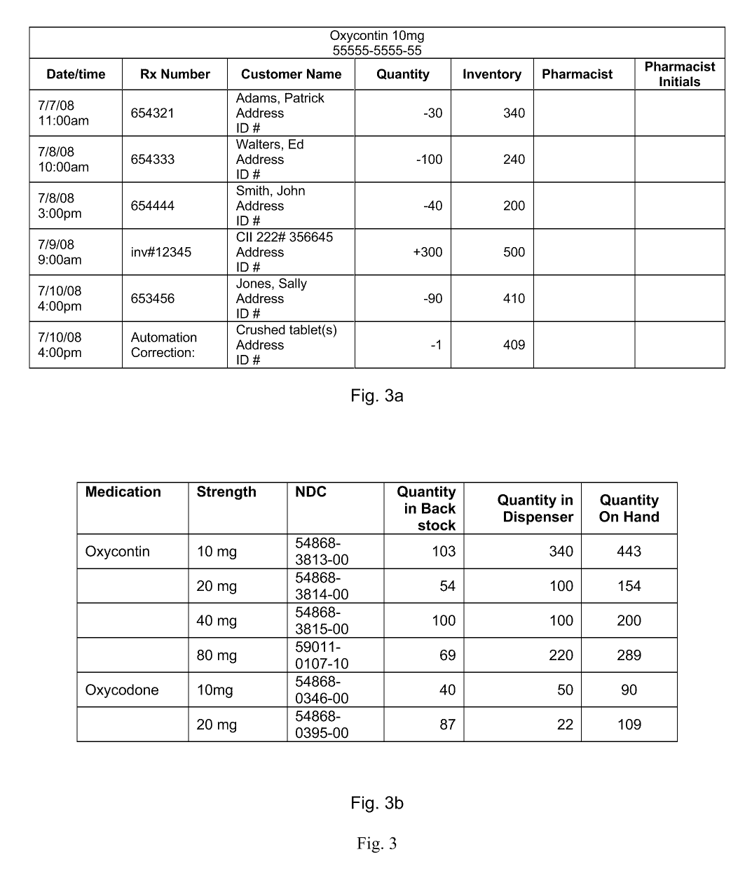

Embodiments of the present invention can have compartments for back stock inventory to insure all product is secure. FIG. 3a is an illustration of an inventory control log report, and FIG. 3b is an illustration of a perpetual inventory. The inventory control log reports, and the like allow for any real-time reporting of activity with use of the cabinet. Perpetual inventory reports preferably present a running accounting of inventory, including back stock and can be generated for time specific intervals A preferred embodiment comprises the creation, tracking and reporting functionality. A preferred embodiment can inhibit and/or prohibit unauthorized access, adhere to time delays as appropriate, track the quantity and movement of inventory and provide accountability to individual persons for the management of the inventory and reporting. A preferred embodiment provides an electronic perpetual inventory control report which can be delivered electronically.

An embodiment of the present invention comprises reporting and functionality including but not limited to: providing a CII Inventory Control Log and perpetual inventory snapshot report; providing a CIII through CV Inventory Control Log and perpetual inventory snapshot report; correction to perpetual inventory in the case of a miscount, or other problem; time-release dispense; and locking mechanism integration. Embodiments of the present invention comprising software preferably provide user authentication, inventory tracking, control of counting automation and reporting. Embodiments comprise software integration, wherein users preferably can be required to authenticate their identity to open the apparatus or otherwise dispense product and separately authenticate to the software for tracking.

Some embodiments of the present invention are optionally capable of dispensing product at night and/or from an instruction from remote location. Embodiments of the present invention fill a need for not only night dispensing but remote dispensing. As a non-limiting example, in a hospital setting, an embodiment of the present invention is optionally connected to a pharmacy system but placed in a nursing area not located within the pharmacy. When there is a pharmaceutical order into the pharmacy, the pharmacist can make the dose available at the remote location of the present invention.

An embodiment can comprise the required inventory management developed within the software system in an integrated manner (described as an “integrated approach”) and/or it can be developed as a separate, standalone software package that interfaces with an embodiment of the present invention (described as an “interfaced approach”).

Embodiments comprising an integrated approach preferably provide perpetual inventory of the dispensers and/or other containment mechanisms provide back stock storage which is then preferably updated and reported by the software. Embodiments comprising an interfaced approach preferably comprise a separate, standalone software module. Embodiments with this module comprise the ability to keep track of the back stock in the cabinet and communicate with the preferred software to get the current inventory of the dispensers. Operationally this can be done through a defined transactional interface or through any appropriate connection directly to the apparatus database. A reporting mechanism can optionally be part of the separate module.

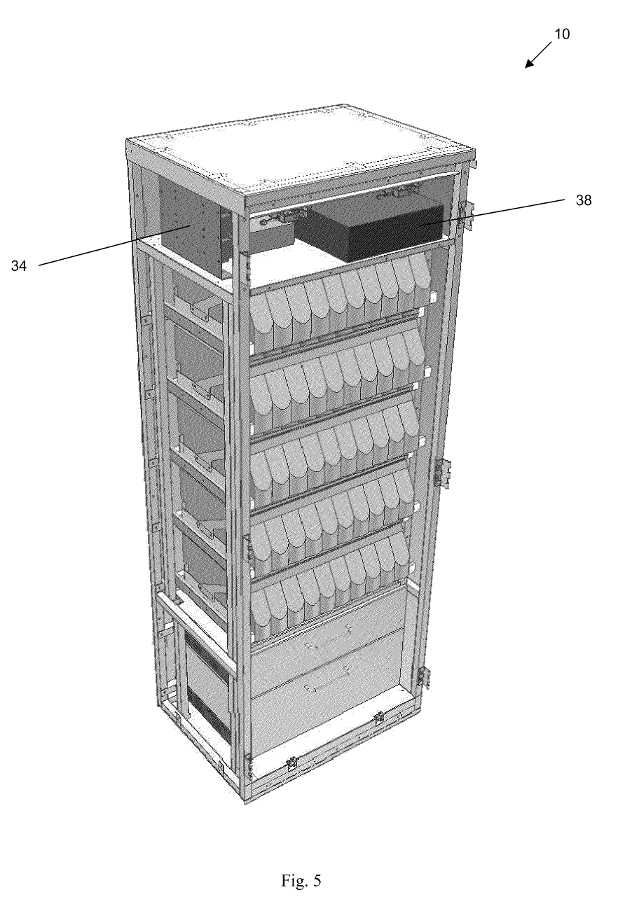

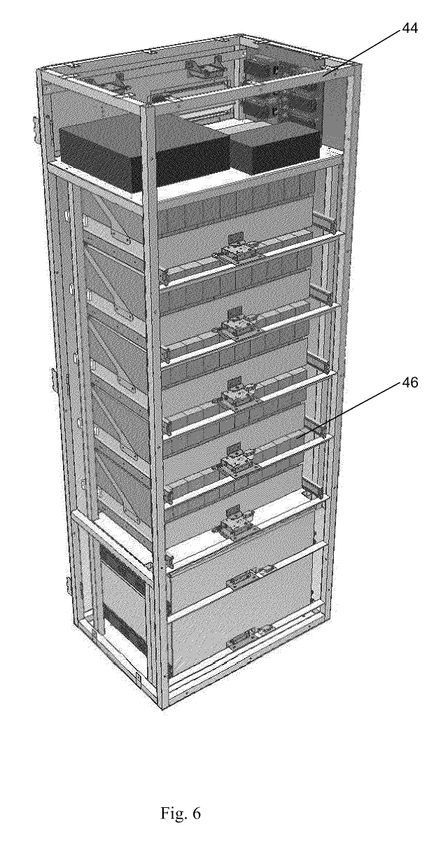

FIGS. 5 and 6 illustrate the “brain” components of the preferred embodiment of the present invention, including central processing unit 38 (see FIG. 5). Cabinet 10 can optionally have time delay mechanisms for safe opening and medication dispensing that can be set for the user's specific needs. In one embodiment, time-delay mechanisms can only be set and reset by authorized agents. In this embodiment, only authorized agents can have access codes to open the safe or dispense items. Authorized agents and level of access can optionally be set by someone with authority, such as an owner or officer of the company that owns cabinet 10. All access and dispensing of the contents of cabinet 10 can produce an electronic log that illustrates a plurality of identifiers including but not limited to date, time, item type, quantity and the person that is accessing the safe or dispensing items. Time delay mechanisms can optionally be manual or electronic and are designed so changes cannot be made by a user to circumvent the delay default prescribed by the authorized authority. Specific time can optionally be set from no time delay, or set to some finite delay. The clock for time delay can be included in an embodiment or disposed at a remote location that communicates with the safe electronically. In one embodiment, all time delay changes can be reported electronically to persons the purchaser deems appropriate. Optionally, log reports can be generated for virtually any pertinent information. FIG. 6 illustrates an embodiment of the shelving mechanism as well as a back portion of dispensers 46.

Cabinet 10 optionally can allow an authorized user to enter a number and scan the items associated with an invoice. Embodiments of the present invention can preferably log the events for reporting and can update the inventory quantity of the correlated back stock.

Embodiments of the present invention preferably comprise software that has a replenishment tracking and control function. Embodiments of the present invention optionally comprise the ability to change a replenishment function, to meet the needs of scheduled inventory replenishments, or increase in need, as non-limiting examples. As a non-limiting example, as the stock bottles are scanned, the resulting events are made available to the inventory control reports including but not limited to back stock inventory, and the person causing the product to be dispensed. Preferably following replenishment, any adjustments can include a logged explanation and remaining stock and/or is preferably scanned back into cabinet 10 and the back stock inventory levels are updated.

In one embodiment, when an item is received and dispensed over an interface and/or entered directly into software in the embodiment, the counting and dispensing of the item is not launched until a configured period of time has expired. Embodiments with the inventory count-out capability and/or any other operation that causes product to go from hopper to buffer (e.g. dispenser maintenance) is also subject to the configured time delay.

Embodiments of the present invention comprise an interface module that preferably communicates with cabinet 10. Communication between the software allows cabinet 10 to preferably let internal software know who has authenticated and what containment mechanisms can be accessed. Data transmitted from cabinet 10 to software can include but is not limited to user authentications, safe-open, safe-close (which can optionally include a drawer or container number), and/or user-created information, user-removed information (to keep user databases in sync).

Embodiments comprising software optionally allow remote capabilities for locking and unlocking cabinet 10. Embodiments comprising software can preferably write reports for inventory control log and/or the perpetual inventory snapshot.

Embodiments comprising an interface approach preferably communicate with an inventory management system. This communication is used for embodiments that need additional data for remote transmission of e.g. controlled medications. The following are non-limiting operational scenarios identified for clarification of the present invention:

Prescriptions are preferably entered in an embodiment of the present invention with the appropriate software. After transmission over an interface, in a standalone environment, the prescription can be accepted by the software if the medication is either in the dispenser or in the cabinet's back stock inventory. Optionally, embodiments can accept any prescription transmitted. Once a prescription is identified and/or cleared and after an appropriate delay interval as expired, the prescription can be processed. If an embodiment is assigned to a dispenser, the count is launched in the dispenser(s). If an embodiment is not assigned to a dispenser (e.g. the prescription is a manual fill) it is alternatively placed into a scheduled state and is available for manual filling. The time/date of the count launch is preferably recorded for reporting purposes since the buffer area of the dispenser is optionally not within the secure area.

When a vial label of an auto-counted prescription is scanned into the software of a preferred embodiment, the dispenser is activated and the pills are released into the vial. Software preferably decrements the inventory of the dispenser while quantity filled of the prescription is incremented by the same amount. When the vial label of a manual prescription is scanned or otherwise entered, the user preferably opens the cabinet, which can optionally be after a time delay, retrieves the stock bottle, scans it and counts the manual fill. The scan in this case serves a plurality of purposes. One is to verify that the proper stock bottle has been selected and another is to create a log entry that the stock bottle was removed from the safe. When a user completes the manual counting and selects an appropriate identifier on the manual fill form, the inventory is decremented and the quantity filled of the vial is incremented. Embodiments of the present invention can require the user to count the pills remaining in the stock bottle and enter the quantity before continuing. Embodiments of cabinet 10 preferably transmit transactions when it is opened and then closed.

Alternatively, during replenishment, a user can open cabinet 10 and scan the stock bottle used to perform the replenishment. This optional scan preferably allows identification of the product being replenished and the dispensers and creates a log entry that the product was removed from the cabinet. At the end of the replenishment, if an inventory adjustment is requested, a user can preferably select a predefined reason or type in a free-form field a reason in order to finalize the log. When new stock of controlled substances is received into the pharmacy, the user preferably increments the inventory in the software to reflect the new quantity. Alternatively, a user can scan the barcode on the stock bottle. If appropriate, embodiments of the present invention can prompt the user to enter the required control number. Embodiments of the present invention preferably comprise appropriate range and format checking of control numbers for quality control. Once stock bottles are scanned the back stock inventory is preferably increased accordingly. Preferred software enters appropriate information to the log and is optionally available for reporting. In one embodiment, during replenishment, if cabinet 10, or some secure portion thereof is not properly closed within a predetermined time, an alarm can optionally be activated.

A preferred embodiment allows a user to select at least one of the plurality of Controlled Substance reports or have the reports automatically printed on a predefined schedule. Preferably an inventory control log report is a chronological list of inventory events for each stocked product. This can be provided to the Drug Enforcement Administration (“DEA”) as documentation of everything that is being dispensed and acquired in real time. Preferably the report is to be printed and/or saved to an electronic file. Embodiments of the present invention allow for software scanning of acquired medications from the wholesaler into back stock. Medications from a wholesaler must correlate with a specific invoice number and ordering control number as issued by the DEA. Users receiving the medications preferably enter an invoice number and a form control number into the preferred embodiment's software. Quantities are preferably added to the total inventory as back stock. All of the events preferably cause records to be created in the logs. Embodiments with the preferred software also preferably require scanning to take inventory out of back stock before it is used to replenish a dispenser. After a prescription is dispensed, the appropriate quantity can be subtracted from inventory. Preferably reports to correlate to inventory control are a chronological accounting of input and outflow of inventory in real time. Alternatively, time delay or back stock reporting can be performed. Preferably, reporting is similar to reports well known in the industry to preferably provide ease of technology and information transfer. Specific labeling is preferably correlated to back stock scanned and placed into the dispensers.

An embodiment employs an electronic inventory control for the monitoring and accounting of medications dispensed. Reports for pharmaceutical controlled substances/controlled substances in the holding area of the safe as well as the medications contained in dispensers of the unit preferably conform to the federal requirements. Reports can be generated, including by way of a non-limiting example, the following information: 1) acquired medications including invoice numbers, quantity acquired from the wholesaler and CII control number from the DEA222 form; and 2) dispensed medications including the name of the recipient, medication, quantity of dispense, prescription number and initials of person(s) initiating the release of the prescription from the unit. These reports can satisfy federal and state requirements for perpetual inventory tracking. Inventory discrepancies can be identified and/or accessed at the location of the apparatus or can be transmitted. Use of software to preferably account for the inventory at virtually any moment and illustrates all acquired medications by date, wholesaler and invoice number as well as the person receiving said order and can account for deficits to inventory for virtually any reason, and/or any other appropriate recordation useful to the industry. All transactions can be identified in any preferred order including but not limited to chronological order. Chronological order preferably illustrates documentation as to the party receiving the medications or reason for loss. Information stored on the software can be preferably accessed and cross referenced by date, medication, person or party receiving medications, location of medication acquisition, overages, losses and any other pertinent information to comprise a comprehensive reporting system.

Embodiments of the present invention include but are not limited to software that can interface with various existing pharmacy software systems to allow for the (a) automatic filling and dispensing of the narcotic/controlled substance or non-controlled medications from the safe upon “input” of data into the pharmacy system; and (b) integration of the electronic perpetual inventory system and reports. Cabinet 10 preferably has connectivity capability to communicate with external applications to allow a user to authenticate. User credentials are optionally transmitted to external software. Optionally, a user can authenticate to both cabinet 10 and to external software simultaneously.

Alternative embodiments include but are not limited to virtually any software or software communication method as needed, and/or any combination thereof.

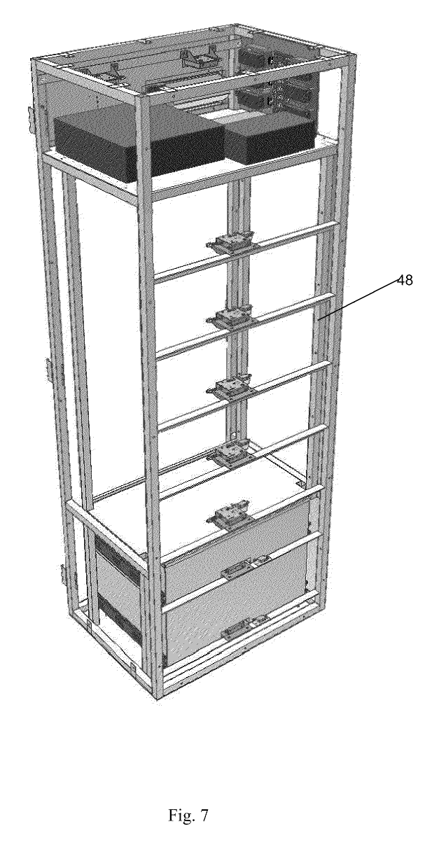

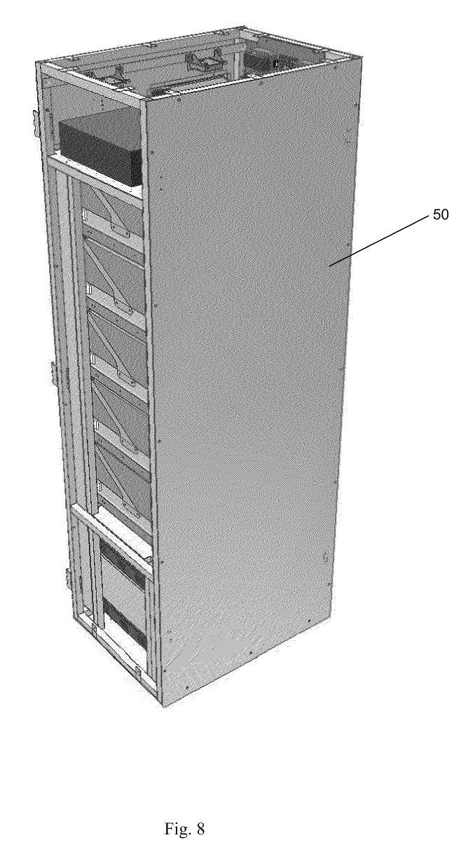

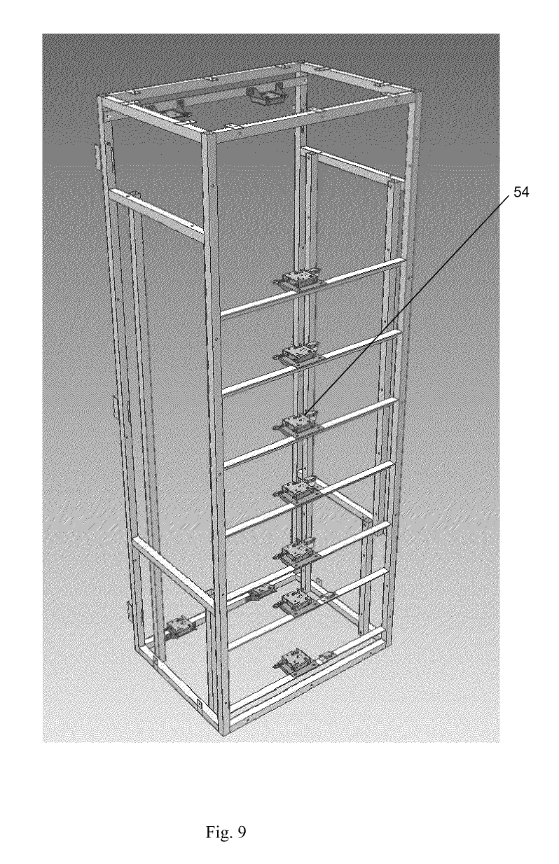

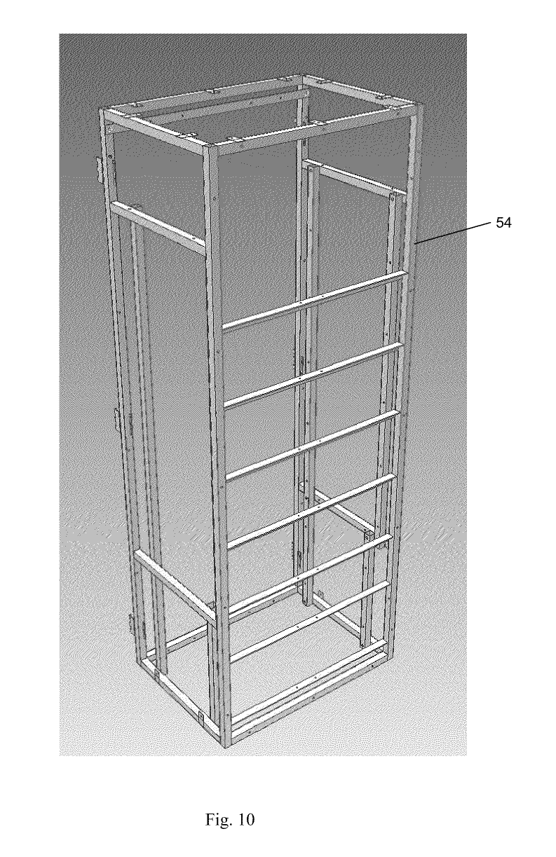

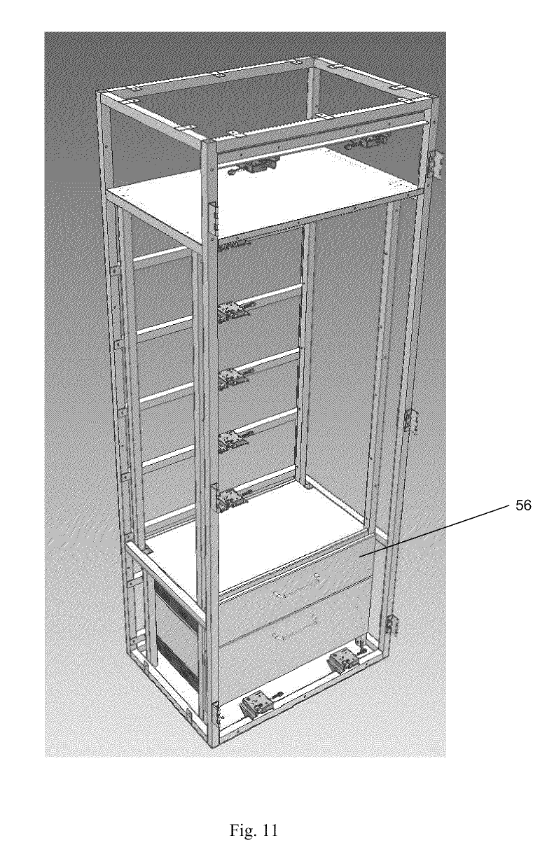

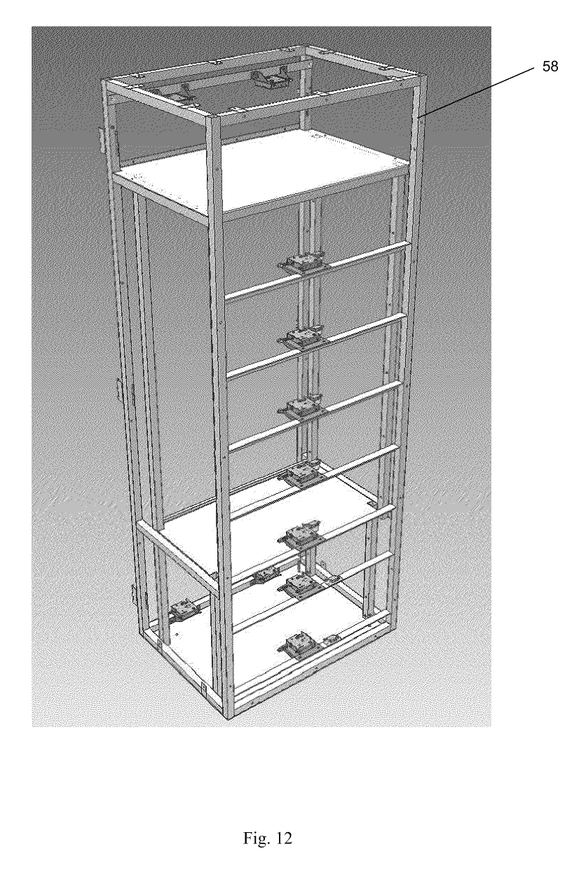

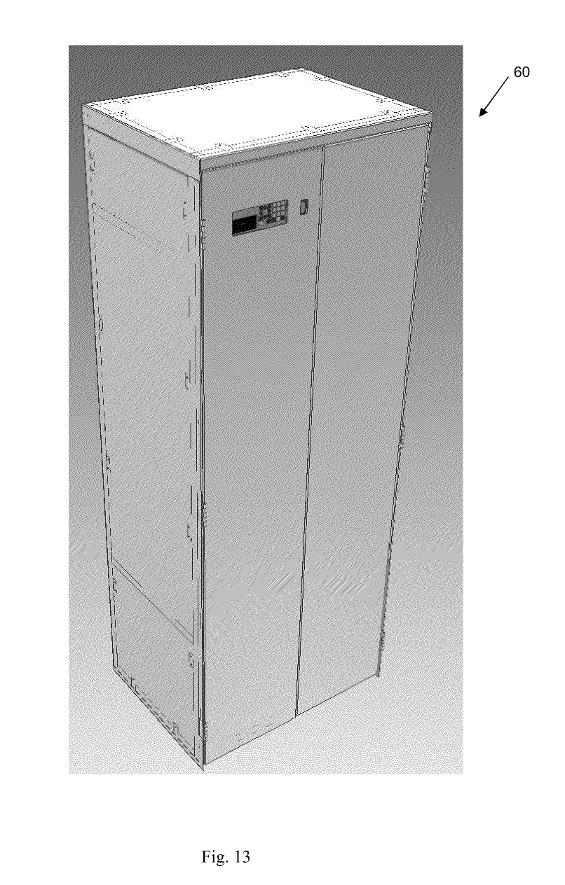

FIGS. 7-13 illustrate components and embodiments of the present invention. FIGS. 7 and 10 illustrate frame 48 and 52 respectively. FIG. 8 illustrates a back panel 50 with a top panel removed. FIG. 9 illustrates shelf locking unit 54. FIG. 11 illustrates a perspective view of an embodiment with bottom drawer 56. FIG. 12 illustrates an embodiment of the present invention with frame 58 for an all dispenser shelving unit. FIG. 13 illustrates a closed and locked embodiment of cabinet 60.

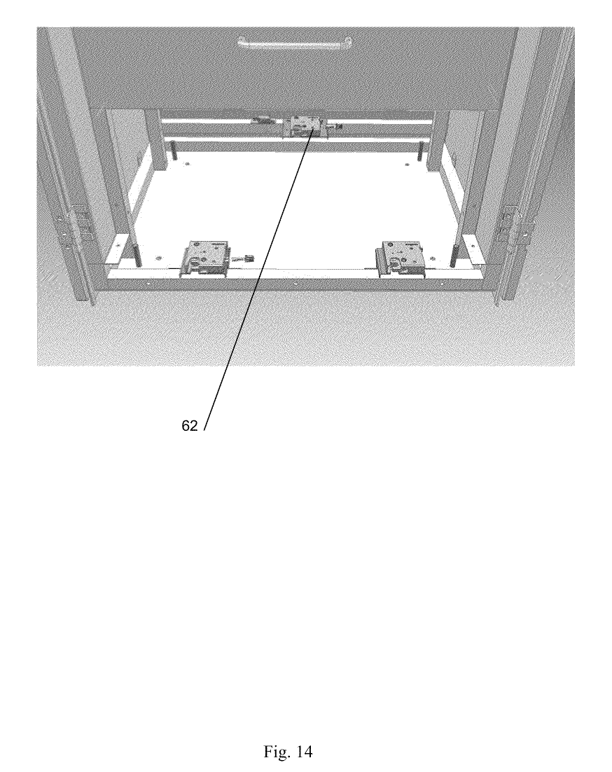

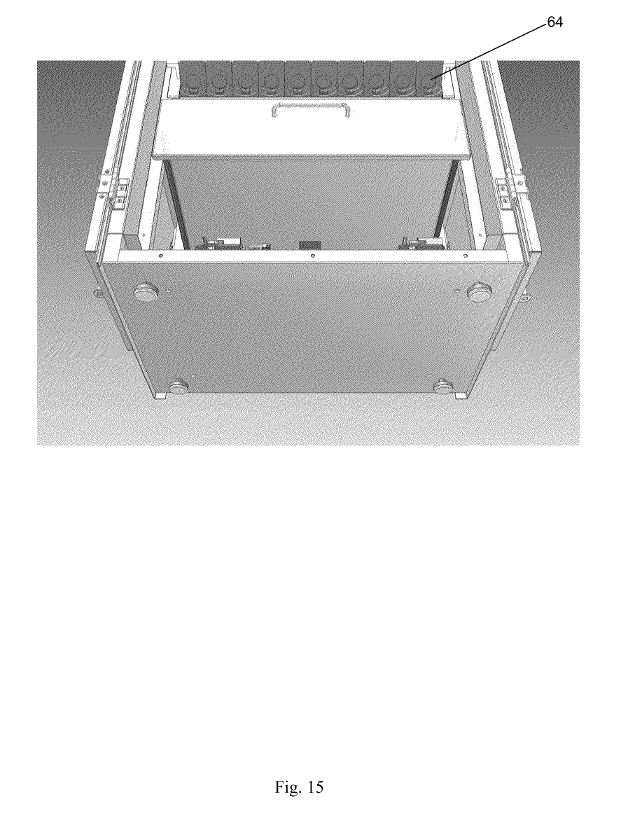

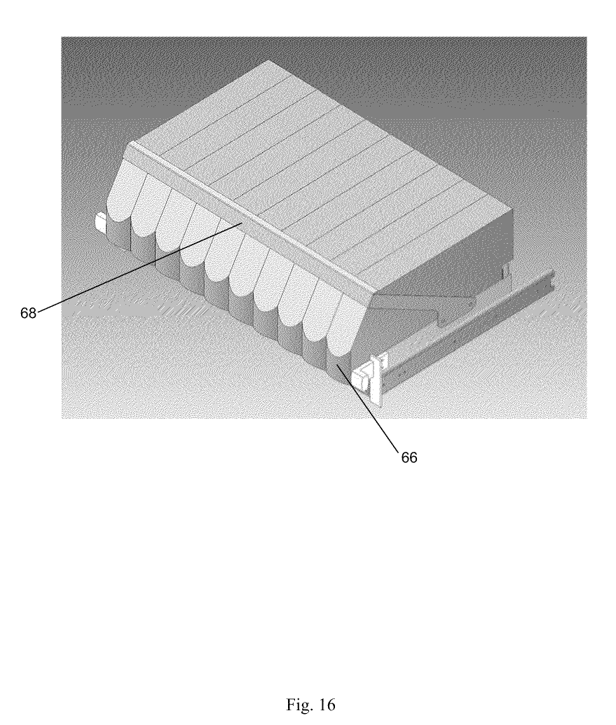

FIGS. 14 through 16 illustrate different, close up views of components of different embodiments of the present invention. FIG. 14 illustrates bottom drawer lock 62; FIG. 15 illustrates a bottom view of dispenser door 64; and FIG. 16 illustrates dispensers 66 and dispenser securing mechanism 68.

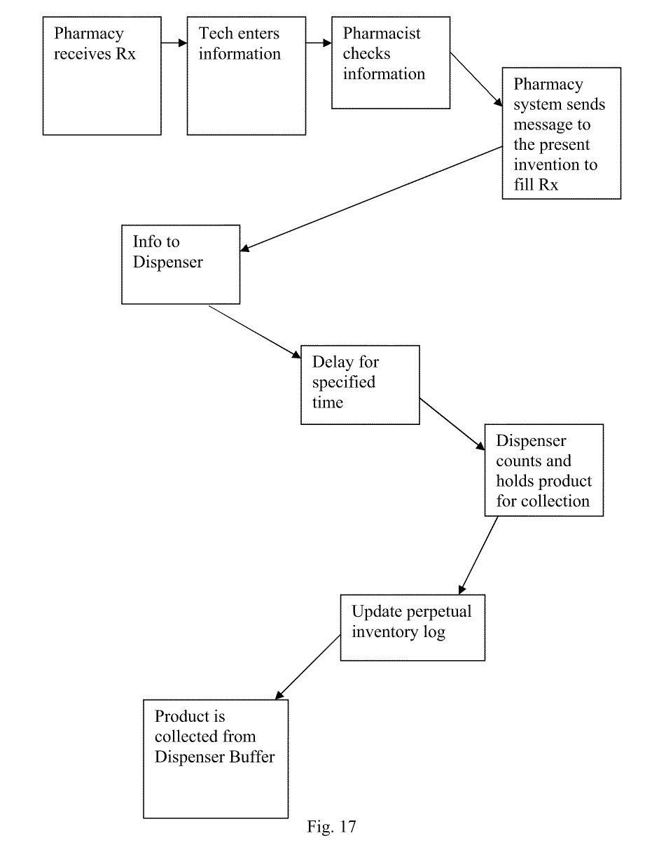

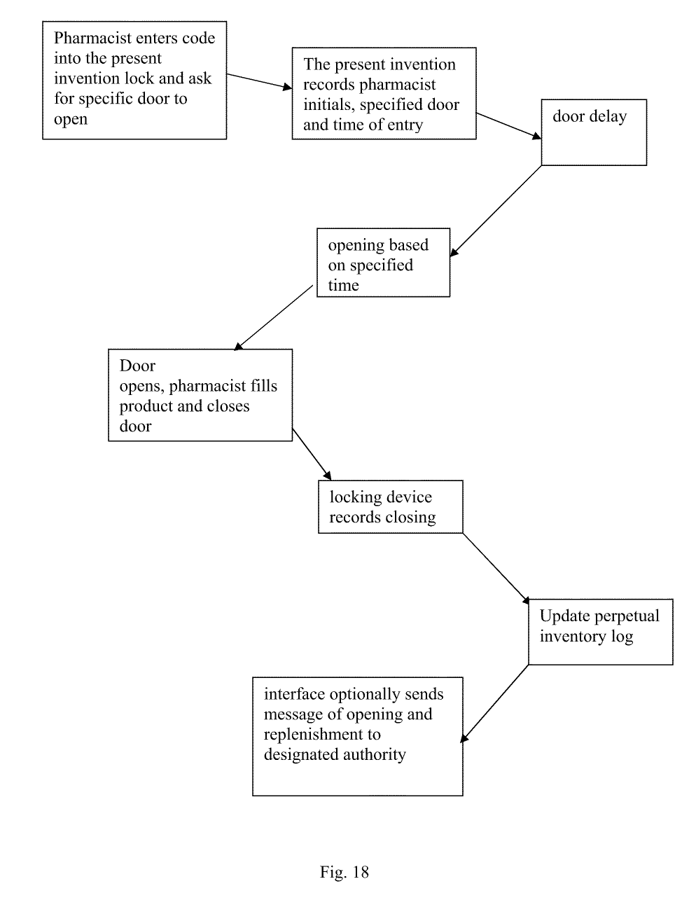

FIGS. 17 and 18 respectively illustrate flow charts according to embodiments of the present invention wherein a prescription is placed and filled, and wherein inventory for a pharmacy is replenished.

In one embodiment the present invention does not comprise any dispensing and/or counting ability. In one embodiment, the present invention can be interfaced with existing software.

Although the invention has been described in detail with particular reference to these preferred embodiments, other embodiments can achieve the same results. Variations and modifications of the present invention can be obvious to those skilled in the art and it is intended to cover in the appended claims all such modifications and equivalents. The entire disclosures of all references, applications, patents, and publications cited above are hereby incorporated by reference.

What is claimed is:

1. A safe for securing and monitoring an inventory of products comprising:
a product storage area;
at least one product dispensing unit;
a locking mechanism inhibiting access to products disposed within said safe, and
a reporting system comprising:
a processor executing software stored in a tangible computer-readable medium, said software causing said processor to generate at least one report; and
said processor executing said software and maintaining an inventory log of dispensed products and a user's access.

2. The safe of claim 1 further comprising an authorization mechanism.

3. The safe of claim 2 wherein said authorization mechanism requires entry of biometric data.

4. The safe of claim 1 wherein said reporting system continuously maintains an inventory control log.

5. The safe of claim 1 wherein said reporting system maintains a log comprising information required to comply with a law or with a governmental regulation.

6. The safe of claim 1 wherein said reporting system can record one or more elements selected from a list consisting of a time when the safe is opened, a time when the safe is closed, a time when a breach in a security feature of the safe occurs, the identity of an individual, and a combination thereof.

7. The safe of claim 1 wherein a specific authorization sequence is required in order to obtain a product stored within said safe.

8. The safe of claim 1 wherein said safe is compartmentalized into a plurality of areas wherein at least some of said areas are independently lockable.

9. The safe of claim 1 wherein said reporting system generates a perpetual inventory snapshot.

10. The safe of claim 1 wherein said safe comprises automated product counting.

11. The safe of claim 1 wherein said safe reports in real-time.

12. The safe of claim 1 further comprising one or more product back-stock containers.

13. The safe of claim 1 further comprising a user-authentication for product dispensing.

14. The safe of claim 1 further comprising a user-authentication for product inventory reporting.

15. The safe of claim 1 wherein said safe is caused to dispense a product from an instruction sent from a remote location.

16. The safe of claim 15 wherein said safe is disposed within a nursing area.

17. The safe of claim 1 further comprising an adjustable product dispensing time delay.

18. The safe of claim 1 wherein the inventory log is directly electronically transmittable.

19. The safe of claim 1 wherein the inventory log comprises a perpetual inventory log.

20. A method for dispensing a product and maintaining a product inventory log comprising:
providing a safe cabinet, the cabinet capable of storing and dispensing a product; and
a computer executing software stored on a tangible computer-readable media wherein the computer maintains an inventory control log for product dispensed from the cabinet and records an identity of a user who accesses the safe cabinet.

21. The method of claim 20 wherein the computer causes product to be automatically dispensed from a secure location within the cabinet.

22. The method of claim 20 wherein the computer causes product to be automatically dispensed from a secure location within the cabinet in response to data from a prescription being input into the computer.

23. The method of claim 22 wherein the data is input into the computer at a location within a same building wherein the cabinet is disposed.

24. The method of claim 22 wherein the data is input into the computer at a location which is not within a same building wherein the cabinet is disposed.

25. The method of claim 20 wherein the inventory control log comprises information required by a governmental body.

26. The method of claim 25 wherein the control log comprises information required by a governmental regulation.

27. The method of claim 20 wherein the cabinet comprises a metal enclosure.

28. The method of claim 20 wherein the software causes the computer to require an authentication prior to dispensing product.

29. The method of claim 20 wherein the product comprises a controlled substance.

30. The method of claim 20 wherein the method requires user authentication prior to dispensing the product.

31. A method for generating an electronic perpetual inventory control log comprising:
providing a system for dispensing pharmaceutical prescriptions, the system automatically maintaining an electronic perpetual inventory control log.

32. The method of claim 31 wherein the control log comports with applicable governmental regulations requiring maintenance of such records.

33. The method of claim 31 wherein the control log can be electronically transmitted to an appropriate governmental body.
